(19) United States
(12) Patent Application Publication
(10) Pub. No.: US 2024/0282039 A1
(43) Pub. Date: Aug. 22, 2024

(54) NAKED-EYE 3D DISPLAY CONTROL METHOD AND APPARATUS, AND ELECTRONIC DEVICE

(71) Applicant: Lenovo (Beijing) Limited, Beijing (CN)

(72) Inventors: Zhenzhou ZHANG, Beijing (CN); Liuxin ZHANG, Beijing (CN)

(21) Appl. No.: 18/420,147

(22) Filed: Jan. 23, 2024

(30) Foreign Application Priority Data
Feb. 21, 2023 (CN) 202310147812.8

(51) Int. Cl. G06T 15/00; G06F 3/01; G06F 3/14

(52) U.S. Cl. CPC G06T 15/00; G06F 3/013; G06F 3/14

(57) ABSTRACT

A naked-eye 3D display control method includes obtaining movement information of a display screen, determining pose information of the display screen according to the movement information, determining a display mode and a display position of a virtual object according to the pose information, and outputting a virtual image of the virtual object at the display position in the display mode.

### CROSS-REFERENCE TO RELATED APPLICATION

This application claims priority to Chinese Patent Application No. 202310147812.8, filed on Feb. 21, 2023, the entire content of which is incorporated herein by reference.

### TECHNICAL FIELD

The present disclosure generally relates to the field of three-dimensional (3D) display technologies and, more particularly, to a naked-eye 3D display control method and apparatus, and an electronic device.

### BACKGROUND

Naked-eye 3D display is able to form an in-screen or out-of-screen display effect by adjusting positive and negative parallax of a binocular parallax image. Under the in-screen display effect, a three-dimensional scene perceived by human eyes is presented behind the display screen, i.e., the three-dimensional scene and the human eyes are on different sides of the screen. Under the out-of-screen display effect, the three-dimensional scene perceived by the human eye is presented in front of the display screen, i.e., the three-dimensional scene and the human eyes are on the same side of the screen. However, the current naked-eye 3D display effect is still not ideal.

### SUMMARY

In accordance with the present disclosure, there is provided a naked-eye 3D display control method including obtaining movement information of a display screen, determining pose information of the display screen according to the movement information, determining a display mode and a display position of a virtual object according to the pose information, and outputting a virtual image of the virtual object at the display position in the display mode.

Also in accordance with the present disclosure, there is provided an electronic system including at least one processor and at least one memory storing executable program instructions that, when executed by the at least one processor, cause the at least one processor to obtain movement information of a display screen, determine pose information of the display screen according to the movement information, determine a display mode and a display position of a virtual object according to the pose information, and output a virtual image of the virtual object at the display position in the display mode.

### BRIEF DESCRIPTION OF THE DRAWINGS

FIG. 1 is a schematic diagram of a principle of naked-eye 3D display consistent with the present disclosure.

FIG. 2 is a flow chart of a naked-eye 3D display control method consistent with the present disclosure.

FIG. 3 is a schematic diagram showing viewing effect before or after moving a display screen.

FIG. 4 is a schematic diagram of showing effect before or after moving a display screen consistent with the present disclosure.

FIG. 5 shows a schematic positional relationship when a display screen moves close to a user consistent with the present disclosure.

FIG. 6 shows another schematic positional relationship when a display screen moves close to a user consistent with the present disclosure.

FIG. 7 is a flow chart of another naked-eye 3D display control method consistent with the present disclosure.

FIG. 8 is a flow chart showing determination of display parameters of a virtual object consistent with the present disclosure.

FIG. 9 is another flow chart showing determination of display parameters of a virtual object consistent with the present disclosure.

FIG. 10 is a schematic structural diagram of a naked-eye 3D display control apparatus consistent with the present disclosure.

FIG. 11 is a schematic structural diagram of an electronic device consistent with the present disclosure.

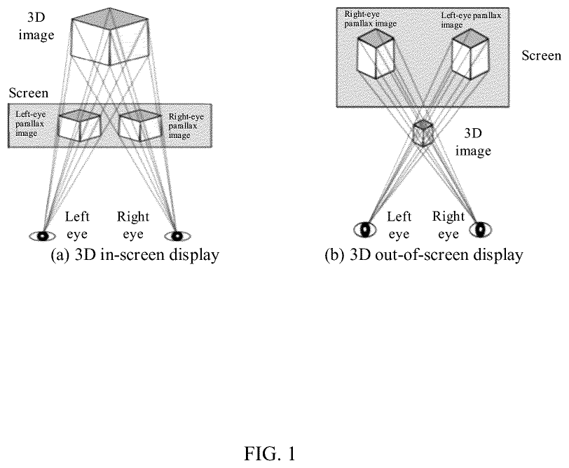

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure.

Various embodiments of the present disclosure may be applied to an electronic device with a naked-eye 3D display function, and the present disclosure has no limit on product types of the electronic device, and the electronic device may be but is not limited to a smart phone, a tablet, a wearable device, a personal computer (PC), or a netbook, which may be selected according to application requirements.

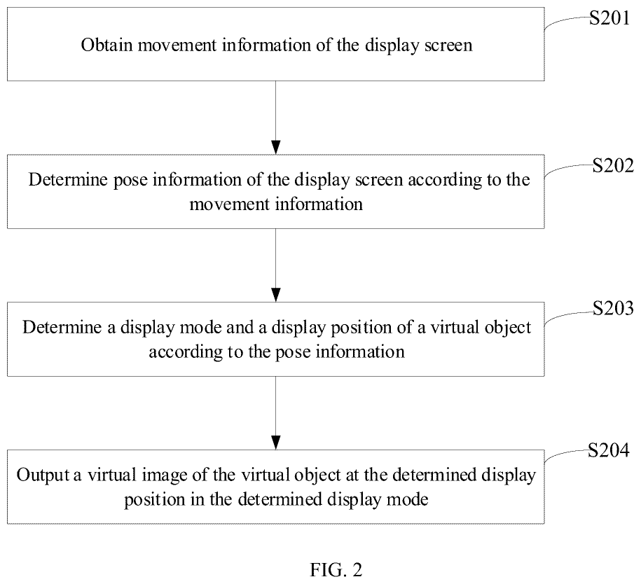

The present disclosure provides a naked-eye 3D display control method. As shown in FIG. 2, which is a flowchart of a naked-eye 3D display control method provided by one embodiment of the present disclosure, in one embodiment, the method may include S201 to S204.

At S201, movement information of a display screen is obtained.

The display screen may be a naked-eye 3D display screen. When using the naked-eye 3D display, users may feel tired as the viewing time continues to extend, or may actively adjust the position or attitude of the naked-eye 3D display screen to match the most comfortable viewing state in their opinion. During the movement of the display screen, to provide the users with a more real and natural visual experience, some processing may need to be performed dynamically following the movement of the display screen. Therefore, the movement information of the display screen may need to be obtained first.

In one embodiment, the movement information of the display screen may be obtained through a sensor installed at the display screen to ensure the accuracy of the detected movement information and provide reliable and accurate basic data for subsequent related processing. The sensor installed at the display screen may include, but is not limited to, at least one of an acceleration sensor, a displacement sensor, or an image sensor. The image sensor may be arranged above the display screen, which is not only convenient for daily use, but also makes the image sensor's viewing field wider. Therefore, algorithms may be applied based on objects in collected images, to accurately determine the movement information of the display screen.

At S202, pose information of the display screen is determined according to the movement information.

The movement information may represent some data detected by the sensor during the movement of the display screen. The pose (e.g., position and/or attitude) of the display screen cannot be directly determined based on this movement information. Some algorithms may need to be used to process or calculate the sensing data accordingly, to determine the pose information of the display screen. Different processing algorithms may be used for data collected by different types of sensors, but the final result may be the pose information of the display screen.

After the pose information of the display screen in the current cycle is obtained, combined with the pose information of the display screen in a previous cycle, the pose change information of the display screen may be determined, for example, a distance and a direction in which the display screen has moved in this cycle may be determined, to determine how a display mode and display position of a virtual object should be adjusted.

At S203, a display mode and a display position of a virtual object are determined according to the pose information.

In one embodiment, the display mode may include but is not limited to an out-of-screen display mode and an in-screen display mode. The display position may represent a display position of the virtual object relative to the display screen, but not the spatial presentation position of the virtual object. In this disclosure, the side of the screen on which the user (human eye) is located is also referred to as an outer side of the screen, and the side of the screen that is opposite to the outer side is also referred to as an inner side of the screen. The in-screen display mode can refer to a display mode in which the virtual object is located on the inner side of the screen. The out-of-screen display mode can refer to a display mode in which the virtual object is located on the outer side of the screen. For example, the display position may be a position at the inner side of the display screen and 50 centimeters away from the screen. In another example, the display position may be a position at the outer side of the display screen and 20 centimeters away from the screen.

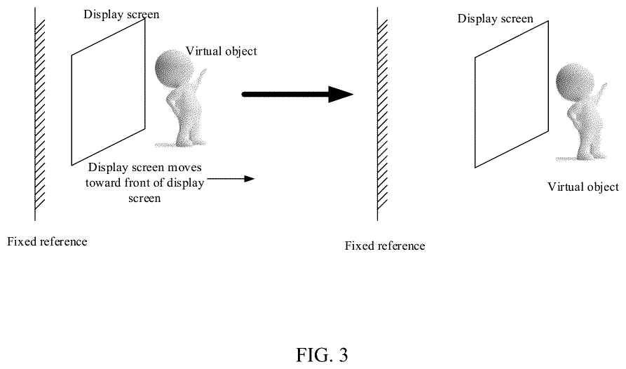

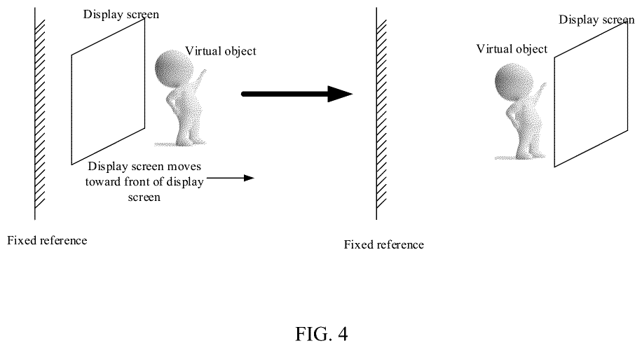

In some examples, the display mode of the virtual scene displayed on the naked-eye 3D display and the display position relative to the display screen are fixed. That is, the virtual scene is bound to the display screen, and changes in the position of the display screen will not cause changes of the display mode and display position of the virtual object. Therefore, when the pose of the display screen changes, the virtual scene will also move with the display screen. The display screen can be thought to be a window in a three-dimensional space. During the movement of the window, the displayed virtual object or scene can only be presented at a fixed position on one side of the display screen. The viewing effect before and after such window movement is shown in FIG. 3. The viewing experience given to the user is not real enough and cannot reflect the natural look and feel of 3D. Consistent with the present disclosure, the display mode and display position of the virtual object or virtual scene may be dynamically adjusted according to the pose information of the display screen. Thus, during the movement of the screen, i.e., the window, in the direction away from the viewer, the spatial position of the virtual object may remain basically unchanged. Only the window moves backward and the virtual object may “pass through” the window in this process. The virtual object originally located behind the window may also change to be in front of the window. That is, the corresponding display mode may change from the original in-screen display to the out-of-screen display. Such viewing effect before and after the display screen moves is shown in FIG. 4.

At S204, a virtual image of the virtual object is output at the determined display position in the determined display mode.

After the display mode and the display position of the virtual object are determined, the virtual object may be directly controlled to be output at the determined display position in the determined display mode. Correspondingly, during the movement of the display screen, the out-of-screen display or the in-screen display of the naked-eye 3D display may be dynamically adjusted following the movement information of the display screen, and the display position of the displayed content may also be changed. Although the display position of the virtual object may change during the movement of the display screen and the display mode may also change, the spatial presentation position of the virtual object may remain unchanged, giving the users the impression that only the display screen is moving and making the entire process more natural and real.

To ensure smooth and continuous display of the naked-eye 3D display content, the execution cycle of the above processes should not be too large, for example, it may be set to 0.2 seconds. The execution cycle may be determined based on comprehensive consideration of device performance and application scenario requirements. Further, in all the examples of display screen movement given in the embodiments in the present disclosure, the moving distance of the display screen in adjacent cycles is relatively large. This does not mean that in actual applications, the display screen moves such a large distance within one cycle. When the virtual object actually moves tens of centimeters in one cycle, the display effect of the virtual object may appear to be intermittent. These embodiments are used only as examples to illustrate the present disclosure.

In the naked-eye 3D display control method provided by the present disclosure, the pose information of the display screen when the display screen moves may be determined, and the display parameters of the virtual object may be adjusted dynamically following changes in the pose information. Therefore, the presentation effect may be consistent with the movement information of the display screen as a whole, making the viewer's 3D viewing experience more real and natural, and improving the user's viewing experience.

There may be different methods to determine the display mode and the display position of the virtual object according to the pose information.

In one embodiment, determining the display mode and the display position of the virtual object according to the pose information may include: determining the display mode and the display position of the virtual object according to the pose information of the display screen in the previous cycle and change data of the pose information in the current cycle.

In the present embodiment, the determination of the display mode and display position of the virtual object may be realized only based on the change data between the previous and current pose information of the display screen. The overall principle may be to keep the spatial presentation position and presentation size of the virtual object unchanged. Under this principle, when the display screen only moves in the forward and backward direction of the display screen, the user may only be able to perceive the forward and backward movement of the display screen, but the position of the virtual object viewed in the space may remain unchanged.

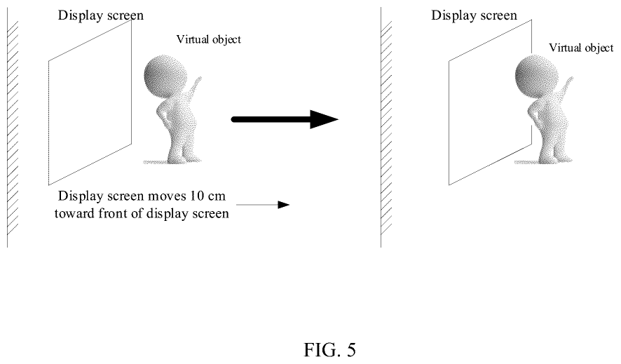

For example, the display screen may be located in the first position in the previous cycle. In the current cycle, it may be detected that the display screen has moved 10 cm closer to the user side. Correspondingly, the actual spatial presentation position of the virtual object may remain unchanged, but the virtual object may move relative to the display screen in a direction away from the viewer for about 10 cm, and may be located in the second position. FIG. 5 is a schematic diagram showing the positional relationship when the display screen moves closer to the user. In the scene shown in FIG. 5, the out-of-screen display mode may be used before the display screen moves. The distance between the display screen and the virtual object may be 30 cm. After the display screen moves, the out-of-screen display mode may be still used, but the distance between the display screen and the virtual object may become smaller, 20 cm. During this process, the spatial presentation position of the virtual object may not change, only the position of the display screen may change.

In this embodiment, the influence of other factors such as the viewer and the virtual object may be not considered, and the display mode and display position of the virtual object may be determined only based on the position difference data before and after the display screen moves. The overall data processing volume may be small and the response may be fast. The method may be suitable for applications that require high response speed.

In another embodiment, determining the display mode and the display position of the virtual object according to the pose information may include: determining the display mode and the display position of the virtual object according to the display position of the virtual object in the previous cycle and the pose information.

In the present embodiment, the overall principle may still be to keep the spatial presentation position and presentation size of the virtual object unchanged, but the implementation may be different from the previous embodiment. In the present embodiment, based on the display position of the virtual object in the previous cycle, the spatial presentation position of the virtual object may be determined through coordinate system conversion After the newest pose information in the current cycle is determined, the display mode and the display position of the virtual object may be determined according to the spatial presentation position.

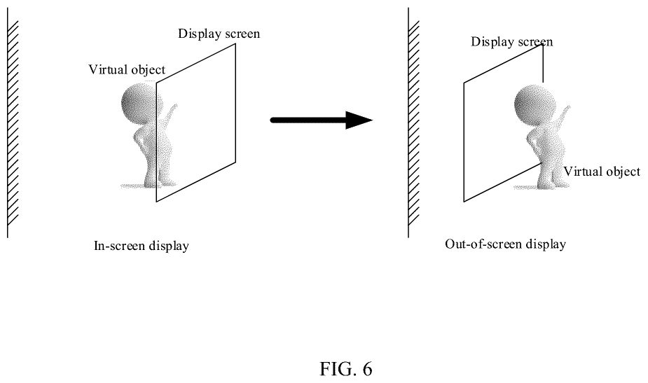

For example, in the previous cycle, the virtual object may be displayed in the in-screen mode, and the display position may be 10 cm away from the display screen. The world coordinates of the display screen may be known, and the spatial presentation position of the virtual object may be determined after coordinate system conversion. Then the display screen may move. The actual movement trajectory may be 25 cm closer to the user side. Based on the relative relationship between the latest pose information in this cycle and the spatial presentation position, it may be determined that the display mode of the virtual object changes to out-of-screen display and the display position may be 15 cm away from the display screen. FIG. 6 is a schematic diagram showing the position relationship when a display screen moves closer to the user corresponding to the above example. Before and after the display screen moves, the display mode of the virtual object may change from the in-screen display to the out-of-screen display, and the display position may also change from 10 cm to the screen on the inner side of the screen to 15 cm to the screen on the outer side of the screen.

In the present embodiment, the display mode and display position of the virtual object in the current cycle may be determined by simultaneously combining the display position of the virtual object in the previous cycle and the pose information o. The algorithm processing may be slightly more complicated than the previous embodiment where the corresponding data is determined only based on the pose information, while the determination results may be more accurate. In actual applications, appropriate methods may be selected to determine the display mode and display position of the virtual object according to the scene usage requirements.

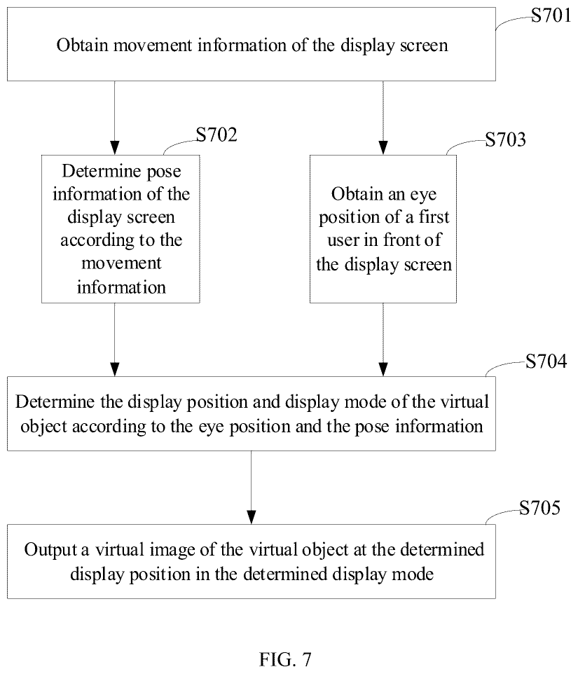

Another embodiment of the present disclosure also provides another naked-eye 3D display control method. As shown in FIG. 7, which is a flowchart of a naked-eye 3D display control method according to the present embodiment, the method includes following processes.

At S701, the movement information of the display screen is obtained.

At S702, the pose information of the display screen is determined according to the movement information;

At S703, an eye position of a first user in front of the display screen is obtained.

At S704, the display mode and the display position of the virtual object are obtained according to the eye position and the pose information.

At S705, a virtual image of the virtual object is output at the determined display position in the determined display mode.

Generally speaking, the movement of the display screen during use may include movement away from the viewer and movement close to the viewer. Therefore, in the present embodiment, the eye position of the first user in front of the display screen may be also obtained. After the eye position is determined, the distance between the eye position and the display screen may be obtained subsequently, which may be used to determine the display mode and display position of the virtual object subsequently.

In one embodiment, an image of the first user's head in front of the display screen may be first collected through a camera installed on the display screen, and then the position of the user's eye, or the distance between the user's eye and the display screen, may be determined based on the image recognition algorithm. The distance and orientation of the user's eye from the display screen may be determined based on the image recognition algorithm. The position of the user's eye may be determined based on the known position of the display screen after determining the distance and orientation of the user's eye from the display screen. In another embodiment, an eye movement algorithm may be directly used to locate the spatial position of the user's eye.

In the present embodiment, not only the movement of the display screen but also the movement of the user may be taken into consideration. When the user feels that his eye and body are tired while watching the naked-eye 3D display, the user may move his body backward to lean on the back of the chair, and pull the display forward or push the display back. Therefore, the eye position and pose information may be combined to determine the display mode and display position of the virtual object, which is more comprehensive and suitable for a variety of application scenarios.

The specific method of determining the display mode and display position of the virtual object based on the eye position and pose information will be introduced in detail in later embodiments, and will not be described in detail here.

In the naked-eye 3D display control method provided by the present embodiment, the scene where the user's eye moves may be considered. By combining the eye movement with the movement of the display screen, the display mode and display position of the virtual object may be determined comprehensively. The overall processing result may be more humane, to provide users with real and natural 3D display effects in a variety of application scenarios.

In one embodiment shown in FIG. 8 which is a flowchart of determining the display parameters of the virtual object, determining the display mode and the display position of the virtual object according to the eye position and the pose information may include following processes.

At S801, a relative position change information of the display screen relative to the eye is determined according to the eye position and the pose information.

At S802, the display mode and the display position of the virtual object are determined according to the relative position change information.

The present embodiment does not pay attention to the user's eye position and the specific movement direction and distance of the display screen, but only considers the relative position changes between them in the previous cycle and this cycle. The display mode and display position of the virtual object may be determined based on the relative position between the user's eye position and the display screen.

If the distance between the user's eye position and the display screen becomes longer, the display position of the virtual object may move relative to the display screen in a direction closer to the user. When the distance between the user's eye position and the display screen becomes shorter, the display position of the virtual object may move relative to the display screen in a direction away from the user.

For example, the distance between the display screen and the user's eye may be 50 cm before the movement, and the distance between the display screen and the user's eye after the movement may be 70 cm. When determining the display mode and display position of the virtual object, how the display screen moves or how the user's eye moves may not be considered, and the display mode and display position of the virtual object in this cycle may be determined only based on the relative position change information and the display position of the virtual object in the previous cycle.

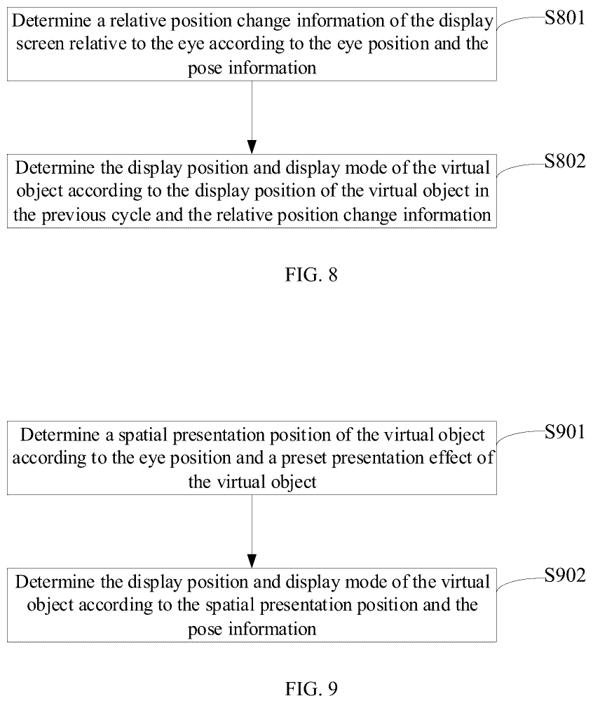

In another embodiment shown in FIG. 9, which is another flowchart of determining the display parameters of the virtual object, determining the display mode and the display position of the virtual object according to the eye position and the pose information may include following processes.

At S901, the spatial presentation position of the virtual object is determined according to the eye position and a preset display effect of the virtual object.

At S902, the display mode and the display position of the virtual object are determined according to the spatial presentation position and the pose information.

In this embodiment, how the display screen and the user's eye move may not be considered overall. After the user's eye position is determined, the display position of the virtual object may be determined based on the display effect of the virtual object preset in the system. For example, when the presentation effect of the virtual object is preset in the system to include the first distance between the virtual object and the user's eye, the spatial presentation position of the virtual object may be determined after the user's eye position is determined. When the spatial presentation position of the virtual object and the pose information of the display screen are determined, the display mode and display position of the virtual object may be further determined.

In one example, the system presets the distance between the virtual object and the user's eye to 2 meters. When the user's eye position is determined, the spatial presentation position of the virtual object may be determined; and at this time, the distance between the display screen and the user's eye is 1.5 meters. Therefore, it may be determined that the display mode of the virtual object is in-screen display, and the display position is 0.5 meters inside the screen. Of course, this example is only used to illustrate the present disclosure, and does not limit the scope of the present disclosure.

In this embodiment, the display mode and display position of the virtual object may be determined with reference to the display effect of the virtual object preset in the system, which ensures that the user's viewing effect is maintained basically in a stable state no matter how the user's eye and/or the display screen move. The user's comfort when using naked-eye 3D displays may be ensured.

In various embodiments, the display mode may include the in-screen display and the out-of-screen display. Correspondingly, outputting the virtual image of the virtual object at the determined display position in the determined display mode may include: when the distance between the spatial presentation position corresponding to the display position and the eye position is larger than the distance between the display screen and the spatial presentation position corresponding to the display position, using the in-screen display mode to output the virtual image of the virtual object at the display position; and, when the distance between the spatial presentation position corresponding to the display position and the eye position is smaller than the distance between the display screen and the spatial presentation position corresponding to the display position, using the out-of-screen display mode to output the virtual image of the virtual object at the display position.

When the distance between the spatial presentation position of the virtual object and the user's eye is greater than the distance between the spatial presentation position and the display screen, the display screen may be located between the spatial presentation position and the user's eye. Therefore, only the in-screen display mode may be used to display the virtual image, such that the virtual object viewed by the user is further away from the display screen. When the distance between the spatial presentation position of the virtual object and the user's eye is less than the distance between the spatial presentation position and the display screen, the display screen may be located between the spatial presentation position and the user's eye. Therefore, only the out-of-screen display may be used to display the virtual image such that the virtual object viewed by the user is close to the display screen.

Further, in actual application scenarios, there may also be multiple users in front of the naked-eye 3D display. In this case, it may be necessary to determine the first user from the multiple users, and make subsequent relevant judgments or processing based on the eye position of the first user, to determine the display mode and display position of the virtual object. A variety of implementations may be used to determine the first user from the multiple users. For example, in one embodiment, a user in the best viewing area in front of the display screen may be determined as the first user. In another embodiment, based on pre-stored images of authorized users, an authorized user from multiple users may be determined as the first user. The present disclosure does not specifically limit the method of determining the first user.

In the present disclosure, when the display screen moves, the pose information of the display screen may be determined, and the display parameters of the virtual object may be adjusted dynamically according to the change of the pose information. Therefore, the 3D viewing experience of the viewer may be more real and lifelike, improving the user's viewing experience.

For the foregoing method embodiments, for the sake of simple description, they are all expressed as a series of action combinations. However, those skilled in the art should know that the present disclosure is not limited by the described action sequence. According to this disclosure, some processes may be performed in other orders or simultaneously. Further, those skilled in the art should also know that the embodiments described in the specification are preferred embodiments, and the actions and modules involved are not necessarily necessary for the present disclosure.

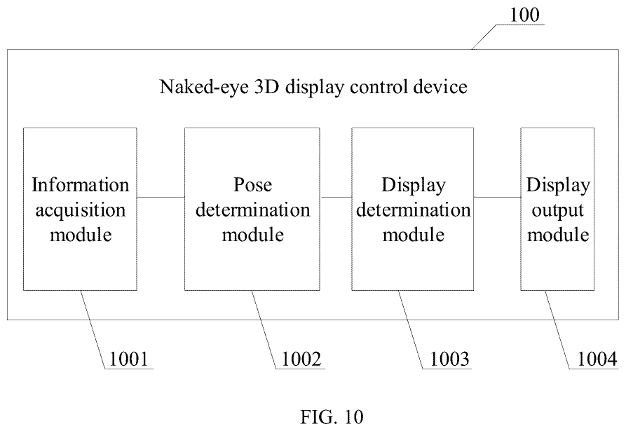

The present disclosure also provides a naked-eye 3D display control apparatus. In one embodiment as shown in FIG. 10, which is the structural diagram of the naked-eye 3D display control apparatus 100, the apparatus 100 includes:
an information acquisition module 1001, configured to obtain movement information of the display screen;
a pose determination module 1002, configured to determine pose information of the display screen according to the movement information;
a display determination module 1003, configured to determine a display mode and a display position of a virtual object according to the pose information; and
a display output module 1004, configured to output a virtual image of the virtual object at the determined display position in the determined display mode.

In the naked-eye 3D display control apparatus provided by the present disclosure, when the display screen moves, the pose information of the display screen may be determined, and the display parameters of the virtual object may be adjusted dynamically according to the change of the pose information. Therefore, the 3D viewing experience of the viewer may be more real and lifelike, improving the user's viewing experience.

In one embodiment, the display determination module may be configured to: determine the display position and display mode of the virtual object according to the pose information of the display screen in the previous cycle and the change data of the pose information in the current cycle.

In one embodiment, the display determination module may be configured to: determine the display position and display mode of the virtual object according to the display position of the virtual object in the previous cycle and the pose information.

In one embodiment, the naked-eye 3D display control apparatus may further include an eye determination module, configured to obtain an eye position of a first user in front of the display screen. Correspondingly, the display determination module may be configured to: determine the display position and display mode of the virtual object according to the eye position and the pose information.

In one embodiment, the display determination module may be configured to: determine a relative position change information of the display screen relative to the eye according to the eye position and the pose information, and determine the display position and display mode of the virtual object according to the display position of the virtual object in the previous cycle and the relative position change information.

In one embodiment, the display determination module may be configured to: determine a spatial presentation position of the virtual object according to the eye position and a preset presentation effect of the virtual object, and determine the display position and display mode of the virtual object according to the spatial presentation position and the pose information.

In one embodiment, the display mode may include the in-screen display and the out-of-screen display. Correspondingly, the display output module may be configured to: when the distance between the spatial presentation position corresponding to the display position and the eye position is larger than the distance between the display screen and the spatial presentation position corresponding to the display position, use the in-screen display mode to output the virtual image of the virtual object at the display position; and, when the distance between the spatial presentation position corresponding to the display position and the eye position is smaller than the distance between the display screen and the spatial presentation position corresponding to the display position, use the out-of-screen display mode to output the virtual image of the virtual object at the display position.

In one embodiment, the information acquisition module may be configured to: obtain the movement information of the display screen based on a sensor at the display screen. The sensor may include but is not limited to at least one of an acceleration sensor, a displacement sensor, or an image sensor.

The description of the above apparatus embodiments is similar to the description of the above method embodiments, and may have similar beneficial effects as the method embodiments. For technical details not disclosed in the apparatus embodiments, the reference may be made to the description of the method embodiments.

The naked-eye 3D display control apparatus may include a processor and a memory. The information acquisition module, the pose determination module, the display determination module, the display output module, or the eye determination module may be stored in the memory as program modules. The processor may execute the above program modules to implement the corresponding functions.

The processor may include one or more kernels, and the one or more kernels may be configured to call corresponding program modules in the memory. Kernel parameters may be adjusted to achieve processing the call-back data,

The memory may include non-volatile memory in a computer-readable medium, a random access memory (RAM), and/or a non-volatile memory in the form of read-only memory (ROM) or flash memory (flash RAM). The memory may include at least one memory chip.

Correspondingly, one embodiment of the present disclosure provides a computer-readable storage medium on which software codes are stored. The medium may be directly loaded into an internal memory of a computer. When the computer program is loaded and executed by the computer, any of the methods described in the above embodiments may be implemented.

Correspondingly, one embodiment of the present disclosure provides a computer program product which may be directly loaded into an internal memory of a computer. When the computer program product is loaded and executed by the computer, any of the methods described in the above embodiments may be implemented.

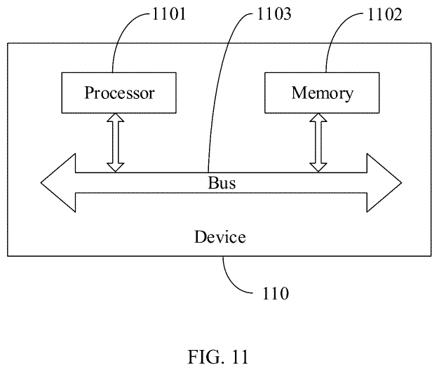

The present disclosure also provides an electronic device for implementing the control method described in the above method embodiments. FIG. 11 is a structural diagram of an electronic device provided by an embodiment of the present disclosure. As shown in FIG. 11, the electronic device 110 includes at least one processor 1101, at least one memory 1102 connected to the at least one processor, and a bus 1103. The communication between the at least one processor 1101 and the at least one memory 1102 may be achieved through the bus 1103. The at least one processor 1101 may be configured to execute program instructions stored in the at least one memory, to implement steps in any of the methods in the embodiments of the present disclosure.

The program instructions may include: obtaining the movement information of the display screen; determining the pose information of the display screen according to the movement information; determining the display mode and the display position of the virtual object according to the pose information; and outputting the virtual image of the virtual object at the determined display position in the determined display mode.

The above-mentioned computer storage media/memory may be read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, optical disk, or compact disc read-only memory (CD-ROM). The above-mentioned computer storage media/memory may also be various electronic devices including one or any combination of the above memories, such as mobile phones, computers, tablet devices, or personal digital assistants.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a . . . ” or “includes a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A naked-eye 3D display control method comprising:
obtaining movement information of a display screen;
determining pose information of the display screen according to the movement information;
determining a display mode and a display position of a virtual object according to the pose information; and
outputting a virtual image of the virtual object at the display position in the display mode.

2. The method according to claim 1, wherein determining the display mode and the display position of the virtual object according to the pose information includes determining the display position and display mode of the virtual object according to the pose information in a previous cycle and change data of the pose information in a current cycle.

3. The method according to claim 1, wherein determining the display mode and the display position according to the pose information includes:
determining the display position and display mode according to the display position of the virtual object in a previous cycle and the pose information.

4. The method according to claim 1, further comprising, before determining the display mode and the display position:
determining an eye position of an eye of a user in front of the display screen;
wherein determining the display mode and the display position according to the pose information includes:
determining the display position and display mode according to the eye position and the pose information.

5. The method according to claim 4, wherein determining the display position and display mode according to the eye position and the pose information includes:
determining relative position change information of the display screen relative to the eye according to the eye position and the pose information, and
determining the display position and display mode according to the display position of the virtual object in the previous cycle and the relative position change information.

6. The method according to claim 4, wherein determining the display position and display mode according to the eye position and the pose information includes:
determining a spatial presentation position of the virtual object according to the eye position and a preset presentation effect of the virtual object; and
determining the display position and display mode according to the spatial presentation position and the pose information.

7. The method according to claim 4, wherein:
the display mode includes an in-screen display mode or an out-of-screen display mode; and
outputting the virtual image at the display position in the display mode includes:
in response to a distance between a spatial presentation position corresponding to the display position and the eye position being greater than a distance between the display screen and the spatial presentation position, outputting the virtual image at the display position using the in-screen display mode; and
in response to the distance between the spatial presentation position and the eye position being smaller than the distance between the display screen and the spatial presentation position, outputting the virtual image at the display position using the out-of-screen display mode.

8. The method according to claim 1, wherein obtaining the movement information of the display screen includes obtaining the movement information of the display screen based on a sensor at the display screen, the sensor including at least one of an acceleration sensor, a displacement sensor, or an image sensor.

9. An electronic device comprising:
at least one processor; and
at least one memory storing executable program instructions that, when executed by the at least one processor, cause the at least one processor to:
obtain movement information of a display screen;
determine pose information of the display screen according to the movement information;
determine a display mode and a display position of a virtual object according to the pose information; and
output a virtual image of the virtual object at the display position in the display mode.

10. The electronic device according to claim 9, wherein the instructions further cause the at least one processor to determine the display position and display mode of the virtual object according to the pose information in a previous cycle and change data of the pose information in a current cycle.

11. The electronic device according to claim 9, wherein the instructions further cause the at least one processor to:
determine the display position and display mode according to the display position of the virtual object in a previous cycle and the pose information.

12. The electronic device according to claim 9, wherein the instructions further cause the at least one processor to:
determine an eye position of an eye of a user in front of the display screen before determining the display mode and the display position; and
determine the display position and display mode according to the eye position and the pose information.

13. The electronic device according to claim 12, wherein the instructions further cause the at least one processor to:
determine relative position change information of the display screen relative to the eye according to the eye position and the pose information, and
determine the display position and display mode according to the display position of the virtual object in the previous cycle and the relative position change information.

14. The electronic device according to claim 12, wherein the instructions further cause the at least one processor to:
determine a spatial presentation position of the virtual object according to the eye position and a preset presentation effect of the virtual object; and
determine the display position and display mode according to the spatial presentation position and the pose information.

15. The electronic device according to claim 9, wherein:
the display mode includes an in-screen display mode or an out-of-screen display mode; and
the instructions further cause the at least one processor to:
in response to a distance between a spatial presentation position corresponding to the display position and the eye position being greater than a distance between the display screen and the spatial presentation position, output the virtual image at the display position using the in-screen display mode; and
in response to the distance between the spatial presentation position and the eye position being smaller than the distance between the display screen and the spatial presentation position, output the virtual image at the display position using the out-of-screen display mode.

16. The electronic device according to claim 9, wherein the instructions further cause the at least one processor to obtain the movement information of the display screen based on a sensor at the display screen, the sensor including at least one of an acceleration sensor, a displacement sensor, or an image sensor.
